(19) United States
(12) Patent Application Publication
(10) Pub. No.: US 2026/0125134 A1
(43) Pub. Date: May 7, 2026

(54) TANDEM BICYCLE TRAILER

(71) Applicant: Karl Paulsen, Tukwila, WA (US)

(72) Inventor: Karl Paulsen, Tukwila, WA (US)

(21) Appl. No.: 18/935,517

(22) Filed: Nov. 2, 2024

(51) Int. Cl. B62K 27/12; B62K 13/02

(52) U.S. Cl. CPC B62K 27/12; B62K 13/025

(57) ABSTRACT

A trailer coupling a towing bicycle to a towed bicycle comprises an arcuate member connected to the frame of the towing bicycle and extending behind the towing bicycle to terminate in a wheel retainer for releasably retaining the front wheel of the towed bicycle above the ground. The trailer further comprises struts depending from the arcuate member, the struts connected to the frame of the towing bicycle so as to provide support for the weight-bearing arcuate member. In embodiments, the wheel retainer is hinged to fold for clearance and storage when the trailer is not used for towing a towed bicycle.

### BACKGROUND OF THE INVENTION

### Field of the Invention

This invention relates generally to bicycles and specifically to trailers or the like specially adapted to be attached to bicycles.

### Description of the Related Art

Adult bicyclists often have need to transport younger children on bicycle trips. One ubiquitous method of transportation is the child's bicycle seat, a small, often contoured seat that is attached to the rear of the adult bicycle, typically behind the adult bicycle seat and above the rear bicycle wheel such as disclosed in Chinese patent CN113767047A.

The principal limitation of the child bicycle seat is that it is practical only for transportation of smaller, lighter-weight passengers. As the weight of the bicycle seat's occupant increases, the added weight above ground level is such that balance becomes precarious. Further, an additional desirable functionality, not provided by the child bicycle seat, is the ability to transport an older child actually riding a bicycle.

Related art has provided tandem towing solutions to enable the transport of another bicycle rider in tandem. For example, U.S. Pat. No. 7,766,358 to Phillips provides a device for connecting bicycles in tandem. Phillips'device comprises a horizontal telescoping linking bar connected between a first connector on the seat post of a lead bicycle and a second connector on the head post or frame of the trailing bicycle. Phillips' arrangement may not be suitable for towing smaller bicyclists, however. Phillips relies on the trailing bicyclist to maintain balance and appropriate trailing trajectory for normal operation, capabilities that may be beyond those of younger riders. Phillips indeed contemplates that the trailing bicycle may deviate from the trajectory of the leading bicycle or even simply fall, unacceptable outcomes for younger riders.

Another example of a tandem towing solution is provided by Snobl in U.S. patent application publication number 2003/0025295. Snobl's solution is an apparatus comprising a first hitch which connects the apparatus to the first bicycle and a second hitch which connects the apparatus to the second bicycle. The second hitch includes a stem which is slid through and secured to the head tube of the second bicycle after the front fork and wheel have been removed from the second bicycle. While Snobl's solution provides stability for the towed bicycle, it entails considerable modification to the configuration of the towed bicycle, requiring disassembly of the towed bicycle prior to towing and reassembly after towing.

Yet another example of tandem towing in the related art is that of Bourbeau in U.S. Pat. No. 6,155,582. Bourbeau's solution, specifically directed to coupling a child's bicycle to an adult's bicycle, is an s-shaped contrivance connected between the towing bicycle and the towed bicycle by way of a first attachment means on the towing bicycle and a second attachment means attached to the towed bicycle. The contrivance elevates the front wheel of the towed bicycle, leveraged by torque supplied by the first attachment means on the towing bicycle. Bourbeau's solution also provides stability for the towed bicycle, but has several limitations. Elevating the towed bicycle's front wheel without additional support has the effect of applying considerable torque to the first attachment means, presenting substantial risk of mechanical failure at the first attachment means. Further, to provide for necessary horizontal swiveling of the towed bicycle, the second attachment means requires an additional hinged component affixed to the towed bicycle, shown as a vertical stem and sleeve arrangement in the preferred embodiment.

What is needed is a solution for a bicycle to tow another bicycle, particularly suitable for towing a child's bicycle, which affords stability for a rider of the towed bicycle. What is needed further is such a solution that is mechanically rugged. Further yet, what is needed is a solution in which the towed bicycle may be attached and detached from the towing configuration without modification or additional components.

### SUMMARY OF THE INVENTION

An apparatus for coupling a towed bicycle to a towing bicycle comprises an arcuate member with a first and a second end. Disposed at the first end of the arcuate member is a fastener fashioned to attach to a portion of the frame of the towing bicycle. Distending from the arcuate member are support struts adapted to fasten to the frame of the towing bicycle and support the arcuate member. Disposed at the second end of the arcuate member is a wheel retainer, adapted to receive and retain the wheel of a towed bicycle. In embodiments, the wheel retainer comprises a curved channel. In such embodiments, the curvature of the wheel retainer roughly matches the curvature of a portion of the front wheel of a bicycle to be towed, and the width of the wheel retainer channel is large enough to receive a towed bicycle's front wheel. The wheel retainer further comprises a means for firmly fastening the front wheel of a towed bicycle to the wheel retainer. In embodiments, the fastening means comprises one or more straps connected to the wheel retainer and designed to buckle tightly around the rim of the front wheel of a towed bicycle.

In operation, the arcuate member is fastened to the towing bicycle, supported by struts affixed to the towing bicycle, and so disposed as to elevate the front wheel of a towed bicycle above the road surface when the towed bicycle is coupled by retention of its front wheel in the wheel retainer. In embodiments, the fastener of the arcuate member attaches to the seat post of the towing bicycle. In embodiments, the support struts of the arcuate member are fastened to seat stays of the towing bicycle. In embodiments, the curved channel of the wheel retainer is fashioned to be folded up when not in use, facilitating clearance and storage for the bicycle when it is not towing.

Stability and mechanical integrity is afforded by the strut-supported connection of the arcuate member to the towing bicycle. Requisite horizontal swiveling of the towed bicycle in transit is afforded by way of rotation of the front fork within the head tube of the towed bicycle as the towing bicycle negotiates curving trajectories While the apparatus is well adapted to tow a bicycle ridden by a child, persons of skill in the art will recognize that the present invention, if properly configured, can couple two bicycles for tandem riding by adults as well.

### BRIEF DESCRIPTION OF THE DRAWINGS

Objects of the present invention as well as advantages, features and characteristics, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a depiction of an embodiment of the invention in use;

FIG. 2 depicts the arcuate member fastener in an embodiment, here attached to the towing bicycle at the towing bicycle's seat post;

FIG. 3 depicts support struts of the arcuate member fastened to seat stays of the towing bicycle in an embodiment of the invention;

FIG. 4a is a detail of the wheel retainer of an embodiment of the invention, unfolded and ready to receive the front wheel of a towed bicycle; and

FIG. 4b is a depiction of the wheel retainer illustrated in FIG. 4a, here folded for storage and clearance;

### DETAILED DESCRIPTION OF THE INVENTION

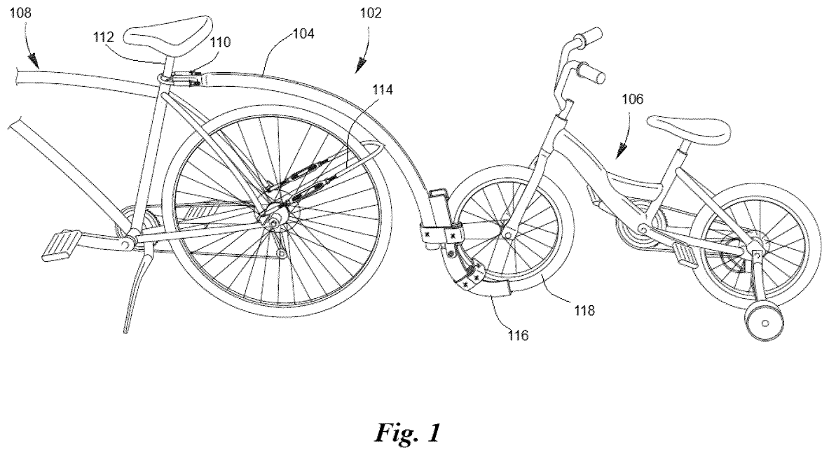

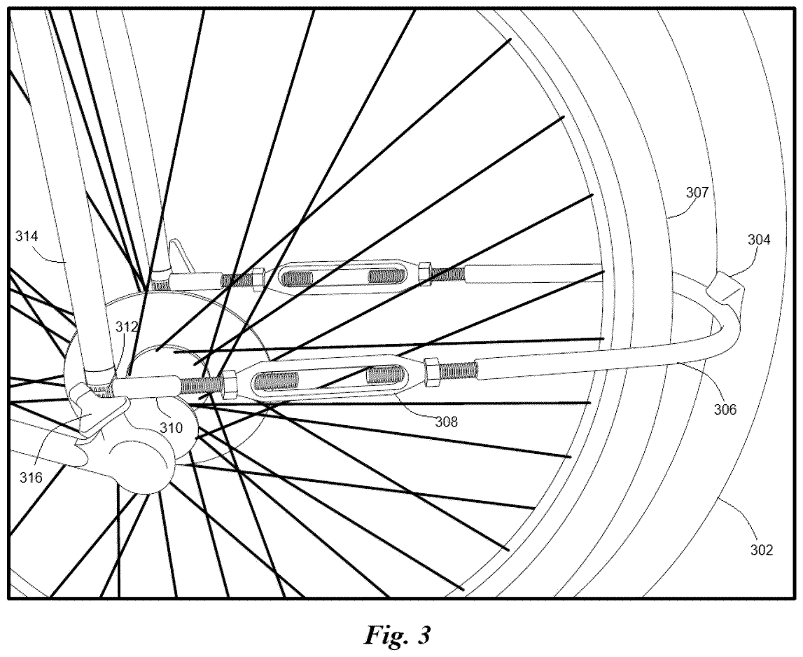

Turning now to the drawings, FIG. 1 depicts an embodiment of the invention in use. Tandem bicycle trailer 102 comprises arcuate member 104, coupling towed bicycle 106 to towing bicycle 108. At one end, arcuate member 104 terminates in a fastener 110, here fastened to seat post 112 of towing bicycle 108. Arcuate member 104 is supported by struts 114, fastened to the frame of towing bicycle 108 as depicted in greater detail in FIG. 3 discussed below.

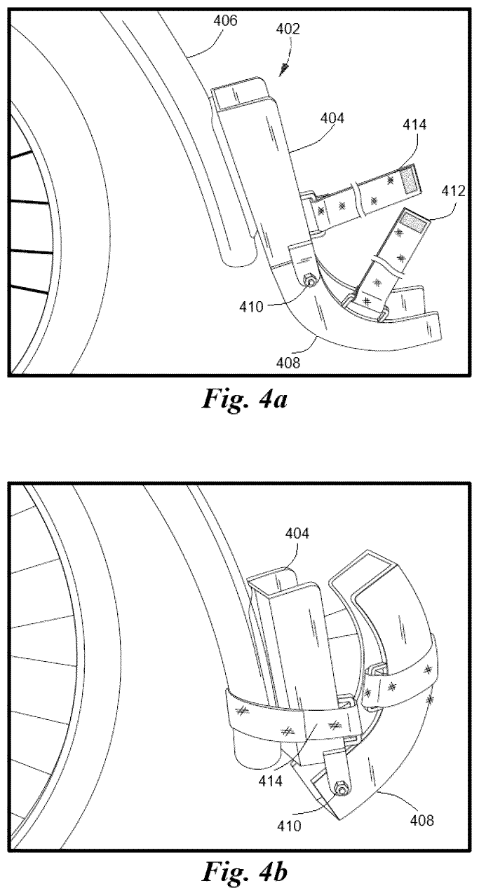

At its other end, arcuate member 104 terminates in wheel retainer 116. Wheel retainer 116 receives and retains the front wheel 118 of towed bicycle 106. Construction and operation of wheel retainer 116 is described in detail below in reference to FIGS. 4a and 4b. Tandem bicycle trailer 102 is installed so as to elevate front wheel 118 of towed bicycle 106 above the road surface

In one embodiment, arcuate member 104 is fashioned from a 36 inch section of square steel tubing 1/16 inch thick and ½ inch in outside diameter, bent in a sweep of 75 to 90 degrees. Fastener 110, struts 114 and wheel retainer 116 are welded onto arcuate member 104.

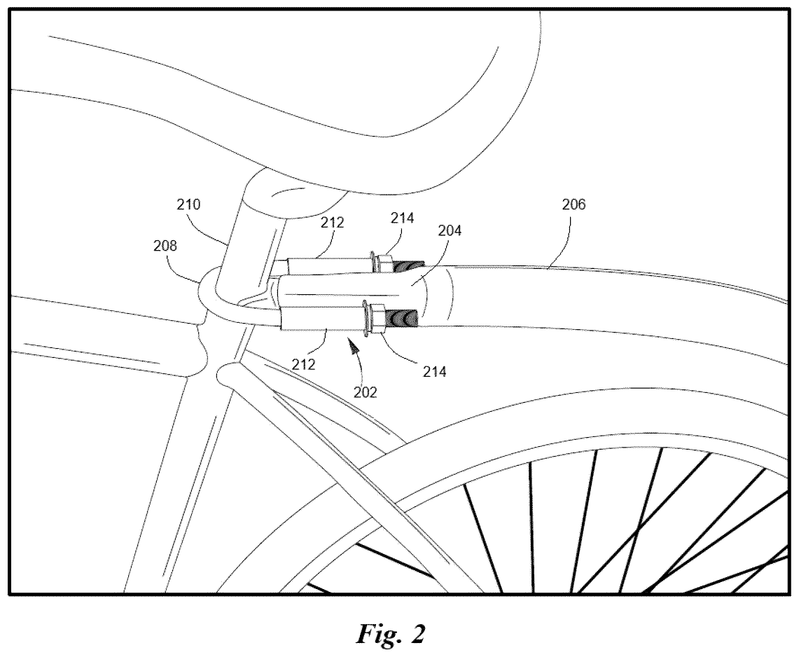

In FIG. 2, the fastener in an embodiment of the invention is depicted secured to the frame of a towing bicycle at the seat post of the bicycle. In this embodiment, fastener 202 comprises a section of solid square steel bar 204 dimensioned at ⅜ inch so as to fit inside the square bar comprising the arcuate member 206 of the invention. A ¼ inch U-bolt 208 wraps around seat post 210 of the towing bicycle. Welded to the sides of steel bar 204 are steel tubes 212 dimensioned and positioned to receive the ends of U-bolt 108. Securing U-bolt 208 within steel tubes 212 are nut and washer arrangements 214, which thereby secure arcuate member 206 to the towing bicycle.

Persons of skill in the art will recognize that methods other than that depicted may be used to secure the trailer to the towing bicycle. Such methods include clamps secured by screw or rachet, cabling or chains, or all other means, and, while releasable attachment may be preferred, such means may include permanent affixing such as by welding for securing the trailer to the towing bicycle. Further, while the depiction shows attachment at the seat post of the bicycle, persons of skill in the art will understand that other portions of the frame of the towing bicycle may be used as the attachment point for the fastener.

FIG. 3 shows detail of support struts of the arcuate member fastened to seat stays of the towing bicycle in an embodiment of the invention. Arcuate member 302 attaches by weld 304 to U-bolt 306. As installed in this embodiment, U-bolt 306 forms the basis of the struts spanning rear wheel 307 of the towing bicycle, U-bolt 306 connecting via turnbuckles 308 to threaded tubes 310 attached to screw/band clamps 312, in turn engaging seat stays 314 of the towing bicycle. In embodiments, threaded tube 312 attaches to clamp 312 via a configuration in which threaded tube 310 is flanged at one end, threaded tube 310 passing through an aperture (not depicted) in clamp 312 and restrained at clamp 312 by the threaded tube's flange. The screw/band clamps 312 in the depicted embodiment are tightened via thumb screws 316. While the depicted embodiment uses screw/band clamps, those with skill in the art will appreciate that other forms of clamps, such as spring, wire or ear clips may be employed to connect the invention's struts to the frame of the towing bicycle.

As will be further understood by those in the art, many other contrivances and embodiments can be constructed to serve as the support struts of the invention. The depicted embodiment attaches struts to the towing bicycle at the towing bicycle's seat stays. Other embodiments may attach struts to other points in the towing bicycle's frame, such as the chain stays or seat tube. What is required is that the struts, in conjunction with the fastener on the arcuate member, provide sufficient mechanical support for elevating the front wheel of the towed bicycle above ground surface, as shown in the embodiments depicted herein. Thereby, in use the trailer provides that the towed bicycle rides only on its rear wheel, its front supported by the trailer.

Turning now to FIGS. 4a and 4b, the wheel retainer is depicted for an embodiment of the invention. Wheel retainer 402 is welded onto arcuate member 406. In this embodiment, wheel retainer 402 comprises an upper portion 404 and a lower portion 408 hingedly joined together and secured by bolt-and-lock-nut 410. In the depicted embodiment, upper portion 404 and lower portion 408 are ⅛ inch thick 2.5 inch u-channel steel. Upper portion 404 is simply an 8 inch section of u-channel steel, while lower portion 408 is a 10 inch section curved to receive the front wheel of a towed bicycle. Upper securing strap 414 is affixed to upper portion 404 and lower securing strap 412 is affixed to lower portion 408.

Straps 412, 414 provide a releasable means of securely retaining the front wheel of a towed bicycle within the channel of wheel retainer 402. As will be understood by those in the art, suitable means for retaining the towed bicycle's front wheel via straps can be selected from a wide range of fastening arrangements, including hook-and-loop fasteners and various buckle contrivances. Further, means other than straps, such as clamps, brackets and the like, may be employed to retain the towed bicycle's wheel. What is required for proper, safe operation of the trailer is that the wheel retainer firmly hold the front wheel of the towed bicycle, preferably in such a way that a user can easily release the wheel when towing is finished.

FIG. 4b illustrates that the wheel retainer in the embodiment shown in FIG. 4a can be folded for storage and clearance. In such embodiments, a lower portion of the wheel retainer, such as lower portion 408 shown here, is folded up, increasing clearance of the trailer above ground level. In the depicted embodiment, lower portion 408 has been folded upward, hinged on bolt-and-lock-nut 410, and is secured via upper securing strap 414 to upper portion 404.

While the invention has been described with a certain degree of particularity, it should be recognized that elements thereof may be altered by persons skilled in the art without departing from the spirit and scope of the invention. Accordingly, the present invention is not intended to be limited to the specific forms set forth in this specification, but on the contrary, it is intended to cover such alternatives, modifications and equivalents as can be reasonably included within the scope of the invention.

I claim:

1. A tandem bicycle trailer, comprising
a connecting member having a first end and a second end,
a fastener affixed to the first end, the fastener adapted to attach to a towing bicycle,
at least one support strut depending from the connecting member intermediate the first end and the second end, the at least one support strut adapted to attach to the towing bicycle, and
a wheel retainer affixed to the second end, the wheel retainer adapted to releasably retain a front wheel of a towed bicycle above a ground level.

2. The tandem bicycle trailer according to claim 1, wherein
the connecting member is arcuate.

3. The tandem bicycle trailer according to claim 2, wherein the arc of the connecting member is in the range of 70 degrees to 90 degrees.

4. The tandem bicycle trailer according to claim 1, wherein
the wheel retainer has an upper portion and a lower portion, the lower portion hingedly connected to the upper portion and configured to fold up with the upper portion when the tandem bicycle trailer is not in use.

5. A towing bicycle, a tandem bicycle trailer and a towed bicycle in combination, comprising
a connecting member having a first end and a second end, the first end attached to the towing bicycle;
at least one support strut depending from the connecting member, the at least one support strut attached to the towing bicycle;
the second end extending behind the towing vehicle and affixed to a wheel retainer, the wheel retainer with a means of releasably retaining a front wheel of the towed bicycle above a ground level.

6. The combination of claim 5, wherein
the means of releasably retaining the front wheel of the towed bicycle comprises at least one strap with a fastener, the fastener selected from the group consisting of a buckle and a hook-and-loop closure.

7. The combination of claim 5, wherein
the means of releasably retaining the front wheel of the towed bicycle comprises a selection from the group consisting of clamps and brackets.

8. The combination of claim 5, wherein
the wheel retainer has an upper portion and a lower portion, the lower portion hingedly connected to the upper portion and configured to fold up with the upper portion when the front wheel of the towed bicycle is not retained therein.

9. The combination of claim 5, wherein
the towing bicycle has a seat post to which the first end of the connecting member is attached; and
the towing bicycle has at least one seat stay to which the at least one support strut is attached.
